(19) United States
(12) Patent Application Publication
(10) Pub. No.: US 2023/0010906 A1
(43) Pub. Date: Jan. 12, 2023

(54) SYSTEM EVENT ANALYSIS AND DATA MANAGEMENT

(71) Applicant: Citrix Systems, Inc., Ft. Lauderdale, FL (US)

(72) Inventors: R V Shouri Gupta, Bangalore (IN); Pakshal Kumar H Dhelaria, Bengaluru (IN)

(73) Assignee: Citrix Systems, Inc., Ft. Lauderdale, FL (US)

(21) Appl. No.: 17/372,703

(22) Filed: Jul. 12, 2021

(51) Int. Cl. G06F 11/30; G06F 16/34; G06F 16/21

(52) U.S. Cl. CPC G06F 11/3075; G06F 11/3086; G06F 16/34; G06F 16/211; G06F 2201/86

(57) ABSTRACT

Techniques are provided for analyzing events incoming through a message broker and configuring a database schema for storing the events based on the analysis. The analysis is performed on all the attributes of the incoming events with reference to a primary identifier of an event source. The analysis determines the characteristics of the attributes, which facilitates development of the database schema with availability, accuracy, existence, and other factors of various attributes. Analysis is supported for various formats of events, such as AVRO, XML, complex JSON, etc. In some examples, the attributes of interest for database schema generation can be provided via a configuration for the respective databases including relational, time-series, analytical, graph, etc. Also, if a given database supports direct ingestion of data through the message broker, then the ingestion specification can be generated.

### BACKGROUND

Analytical services gather data from various sources and build reports, dashboards, and other products that provide insights into the data. The data represent information about entities such as users, devices, networks, and shares, along with correlations among the data, which are collected over time from the entities. The data are analyzed by various models, such as those defined to detect any threats, risks, or vulnerabilities associated with the entities. These models process the data in real time and in batch fashion so that preventive measures, such as responsive actions, are taken to mitigate the threats. The data received and generated during processing by the services are ingested into various data stores, such as time series, graph, relational, or other types of databases, based on the nature of the data (e.g., what the data represents) and how the data is to be used. With growing requirements and needs, a large amount of data is generated continuously, and existing data is enhanced with additional attributes and information which can be leveraged to build more use cases and solutions.

### SUMMARY

One example provides a method of updating a database schema. The method includes receiving a plurality of messages from an application environment; analyzing, as specified by a configuration, each of the messages to produce an analysis including a list of attributes and corresponding attribute values; fetching a schema from either a database or a schema registry associated with the database; updating the schema to produce an updated schema based on one or more of the attributes in the list of attributes; and applying the updated schema to the database.

At least some examples of the method include one or more of the following. The configuration specifies a start time and an end time for messages to be analyzed. The method further includes generating an ingestion specification based on the database and the one or more of the attributes in the list of attributes, and registering the ingestion specification with the database. The method further includes transmitting the analysis and/or the updated schema to an operator console. The method further includes receiving a modified analysis from the operator console, where the modified analysis includes at least one modification to the one or more of the attributes in the list of attributes, and where updating the schema is further based on the modified analysis. The method further includes registering the updated schema with the schema registry associated with the database. The plurality of messages includes a user login event, a security event, a processing event, and/or data representing activity occurring within the application environment. At least one attribute of the plurality of messages includes a numerical value, and the analysis includes a minimum, maximum, average, mean, or a statistical value of the at least one attribute of the plurality of messages. At least one attribute of the plurality of messages includes a text value, and the analysis includes a number of empty, null, duplicate, or missing values of at least one attribute of the plurality of messages.

Another example provides a computer program product including one or more non-transitory machine-readable mediums having instructions encoded thereon that when executed by at least one processor cause a process to be carried out. The process includes receiving a plurality of messages from an application environment; analyzing, as specified by a configuration, each of the messages to produce an analysis including a list of attributes and corresponding attribute values; fetching a schema from either a database or a schema registry associated with the database; updating the schema to produce an updated schema based on one or more of the attributes in the list of attributes; and applying the updated schema to the database.

At least some examples of the computer program product include one or more of the following. The configuration specifies a start time and an end time for messages to be analyzed. The process further includes generating an ingestion specification based on the database and the one or more of the attributes in the list of attributes, and registering the ingestion specification with the database. The process further includes transmitting the analysis and/or the updated schema to an operator console. The process further includes receiving a modified analysis from the operator console, where the modified analysis includes at least one modification to the one or more of the attributes in the list of attributes, and where updating the schema is further based on the modified analysis. The process further includes registering the updated schema with the schema registry associated with the database. The plurality of messages includes a user login event, a security event, a processing event, and/or data representing activity occurring within the application environment.

Yet another example provides a system including a storage and at least one processor operatively coupled to the storage. The at least one processor is configured to execute instructions stored in the storage that when executed cause the at least one processor to carry out a process. The process includes receiving, by an event manager, a plurality of messages from an application environment; analyzing, by the event manager and as specified by a configuration, each of the messages to produce an analysis including a list of attributes and corresponding attribute values; fetching, by the event manager, a schema from either a database or a schema registry associated with the database; updating, by the event manager, the schema to produce an updated schema based on one or more of the attributes in the list of attributes; and applying, by the event manager, the updated schema to the database.

At least some examples of the system include one or more of the following. The configuration specifies a start time and an end time for messages to be analyzed. The process further includes generating, by the event manager, an ingestion specification based on the database and the one or more of the attributes in the list of attributes, and registering the ingestion specification with the database. The process further includes transmitting, by the event manager, the analysis and/or the updated schema to an operator console. The process further includes receiving, by the event manager, a modified analysis from the operator console, where the modified analysis includes at least one modification to the one or more of the attributes in the list of attributes, and where updating the schema is further based on the modified analysis. The process further includes registering, by the event manager, the updated schema with the schema registry associated with the database. The plurality of messages includes a user login event, a security event, a processing event, and/or data representing activity occurring within the application environment.

Other aspects, examples, and advantages of these aspects and examples, are discussed in detail below. It will be understood that the foregoing information and the following detailed description are merely illustrative examples of various aspects and features and are intended to provide an overview or framework for understanding the nature and character of the claimed aspects and examples. Any example or feature disclosed herein can be combined with any other example or feature. References to different examples are not necessarily mutually exclusive and are intended to indicate that a particular feature, structure, or characteristic described in connection with the example can be included in at least one example. Thus, terms like “other” and “another” when referring to the examples described herein are not intended to communicate any sort of exclusivity or grouping of features but rather are included to promote readability.

### BRIEF DESCRIPTION OF THE DRAWINGS

Various aspects of at least one example are discussed below with reference to the accompanying figures, which are not intended to be drawn to scale. The figures are included to provide an illustration and a further understanding of the various aspects and are incorporated in and constitute a part of this specification but are not intended as a definition of the limits of any particular example. The drawings, together with the remainder of the specification, serve to explain principles and operations of the described and claimed aspects. In the figures, each identical or nearly identical component that is illustrated in various figures is represented by a like numeral. For purposes of clarity, not every component may be labeled in every figure.

FIG. 1 is a block diagram of an event analysis and database management system, in accordance with an example of the present disclosure.

FIGS. 2A-B show a flow diagram of an event analysis and database management process that can be implemented in the system of FIG. 1, in accordance with an example of the present disclosure.

FIGS. 3A-C show an example of a configuration, sample incoming messages/events, data/attribute analysis, and a database schema and an ingestion specification corresponding to the analysis that are inputs and outputs of the event analysis and database management process of FIGS. 2A-B, in accordance with an example of the present disclosure.

FIGS. 4A-C show another example of a configuration, sample incoming messages/events, data/attribute analysis, and a database schema and an ingestion specification corresponding to the analysis that are inputs and outputs of the event analysis and database management process of FIGS. 2A-B, in accordance with an example of the present disclosure.

### DETAILED DESCRIPTION

According to some examples of the present disclosure, data is received from various application environments on a regular and ongoing basis. The data can be used for security or analytical purposes in the maintenance of those application environments. For example, incoming messages can include events that are related to user activity (e.g., login and logout) that is monitored for security threats. The data are ingested into one or more databases as part of this process. The ingestion of data involves configuring one or more database schemas and, in some cases, ingestion specifications, that define how the incoming messages are to be stored in the database. For example, certain fields or attributes of the messages may define how the data is represented within the structure of the database(s) in which the data are to be stored. Determining which attributes and the corresponding databases where the data are to be stored, involves analyzing at least a subset of the messages to help define the corresponding database schemas and ingestion specifications that can be subsequently used to process incoming messages.

In some instances, the analysis of the data can be carried out by developers, engineers, or other users for various attributes of interest and its presence in all types of events. After identifying the attributes, engineers, developers, or other users typically write and define the schema and ingestion specifications to store the data in the desired database as per its signature, syntax, etc. The process of data analysis, identifying fields of interest and the writing database schema, and updating the existing schema, are tasks undertaken when changes occur to the use case or to implement enhancements and other requirements. Therefore, there remain non-trivial problems associated with event analysis and management.

To this end, example embodiments of the present disclosure provide techniques for analyzing events incoming through a message broker and configuration of a database schema for storing the events based on the analysis. The analysis is performed on all the attributes of the incoming events with reference to a primary identifier of an event source. The analysis determines the characteristics of the attributes, which facilitates development of the database schema with availability, accuracy, existence, and other factors of various attributes. Analysis is supported for various formats of events, such as AVRO, XML, complex JSON, etc. In some examples, the attributes of interest for database schema generation can be provided via a configuration for the respective databases including relational, time-series, analytical, graph, etc. Also, if a given database supports direct ingestion of data through the message broker, then the ingestion specification can be generated. Various examples will be apparent in light of the present disclosure.

Example System

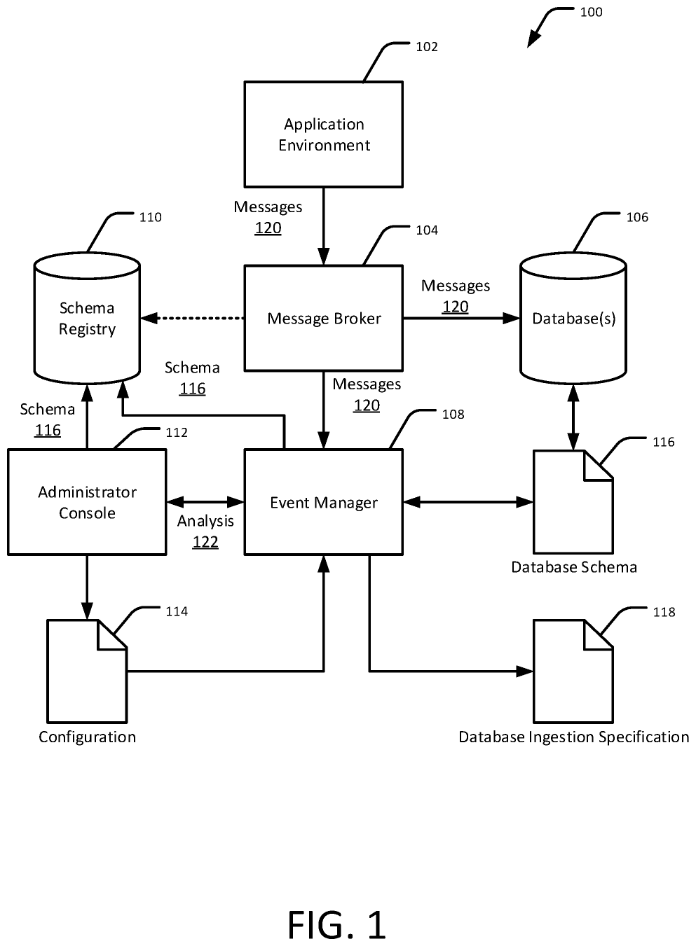

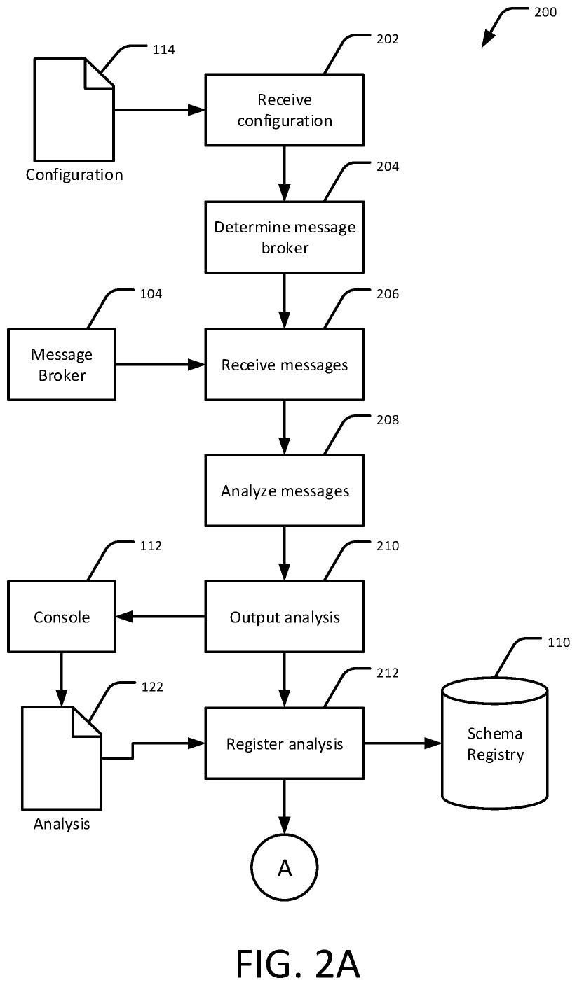

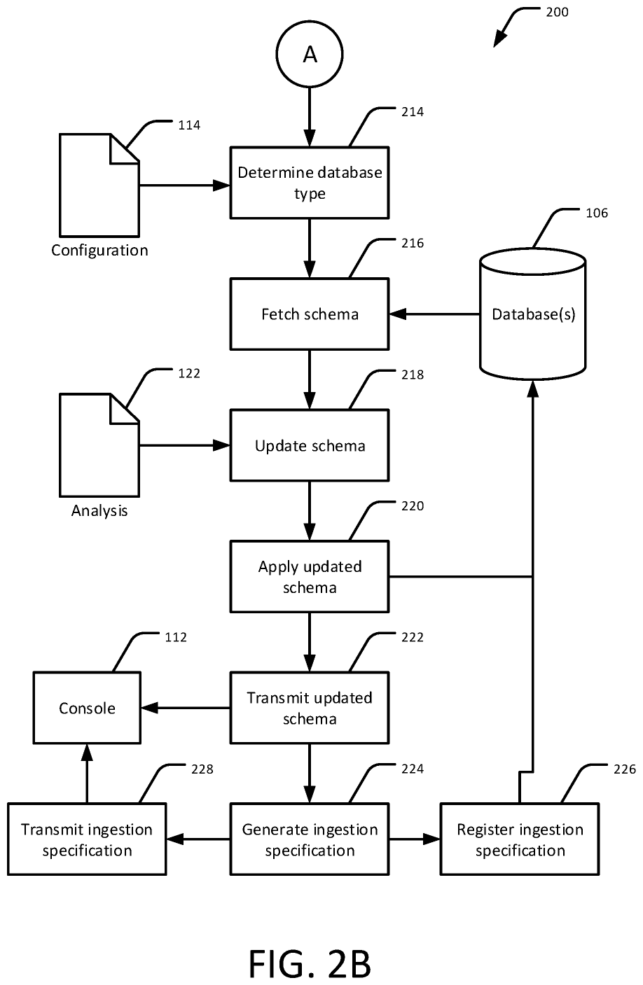

FIG. 1 is a block diagram of an example event analysis and database management system 100, in accordance with an example of the present disclosure. The system 100 includes an application environment 102, a message broker 104, one or more databases 106, an event manager 108, a schema registry 110, and an administrator console 112. The event manager 108 is configured to receive a configuration 114 generated via the administrator console 112, and to produce a database schema 116 and/or a database ingestion specification 118. The administrator console 112 can include any computing device configured to generate the configuration 114 and to receive and process an analysis 122 produced by the event manager 108, such as described with respect to FIGS. 2A-B.

The application environment 102 includes one or more applications that are executing on a client or server computing device, such as applications executing in a virtual workspace or another virtual computing environment that provides computing resources (processing and/or data) to end users. The message broker 104 includes one or more modules configured to provide a standardized flow of data from the application environment 102 to the event manager 108 and to the database(s) 106. In some examples, the message broker 104 receives one or more messages 120 from the application environment 102. The messages 120 represent events or other actions that occur within, and are generated by, the application environment 102, such as user login events, security events, processing events, or other data representing activity occurring within the application environment 102. The message broker 104 routes the messages 120 to the event manager 108 and/or the database 106.

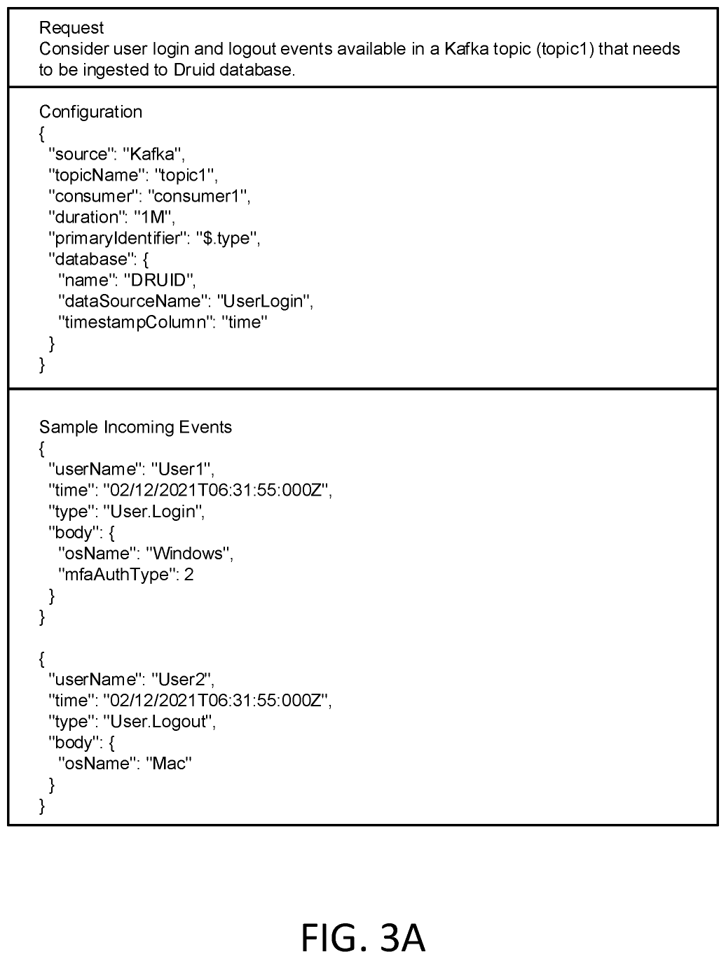

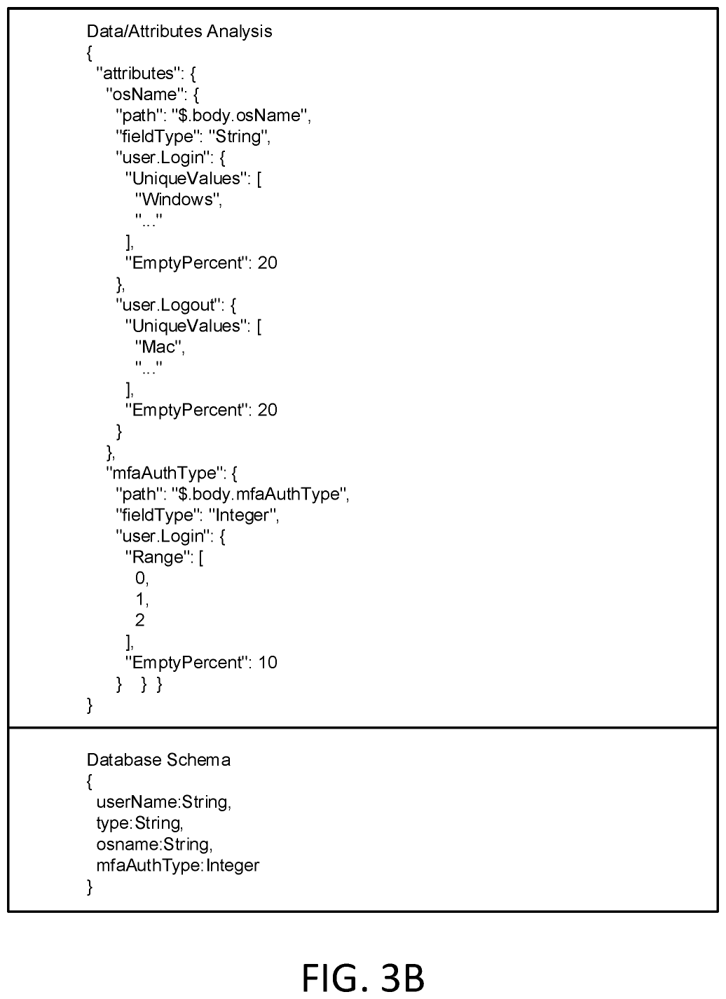

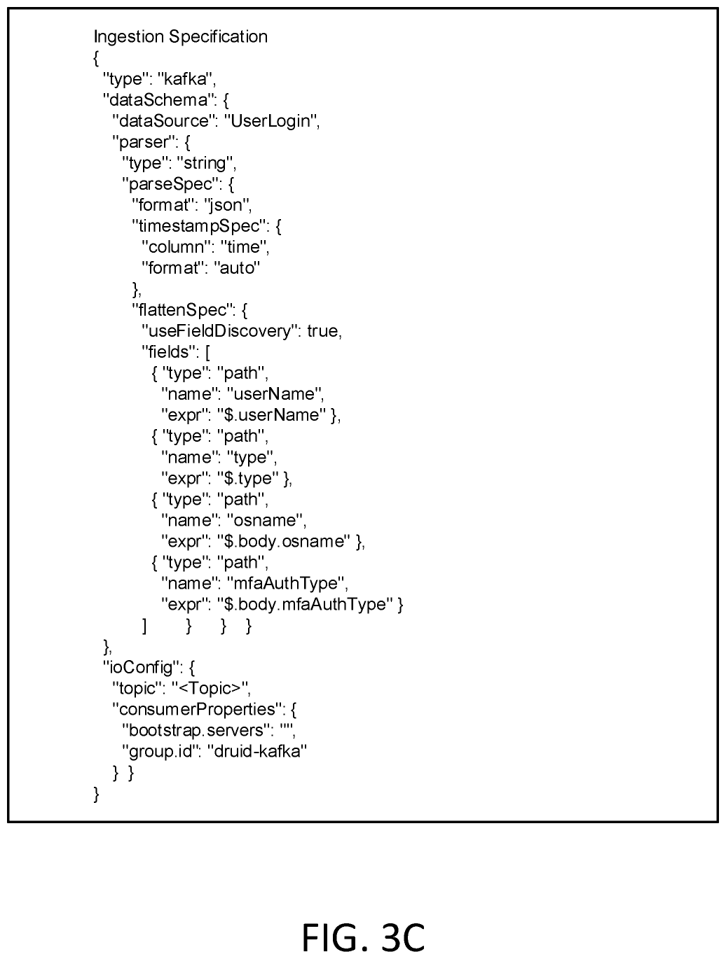

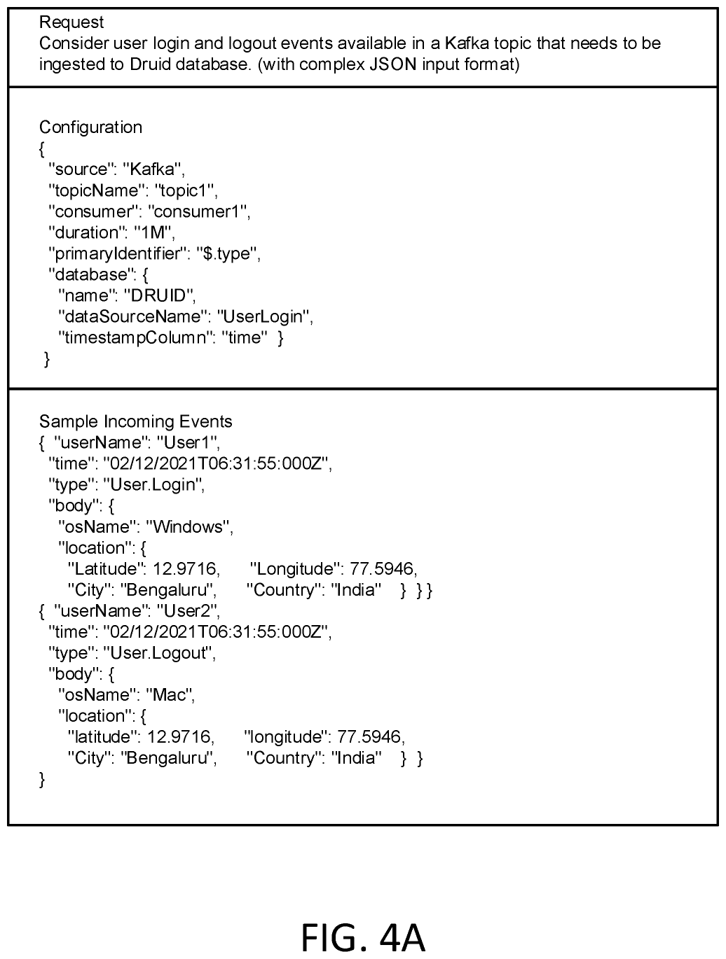

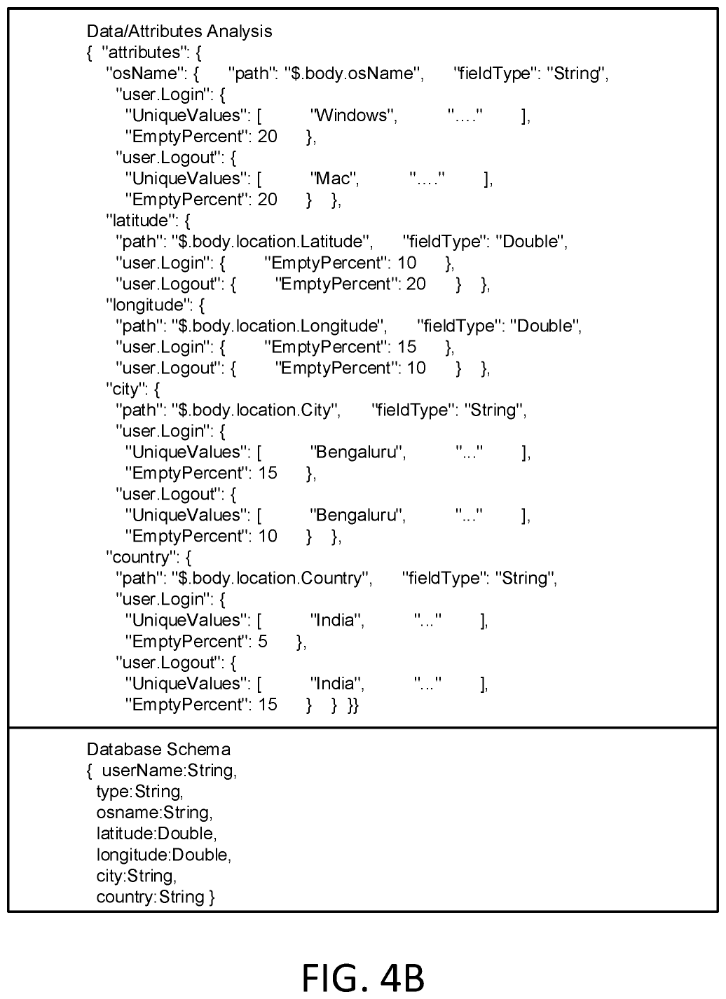

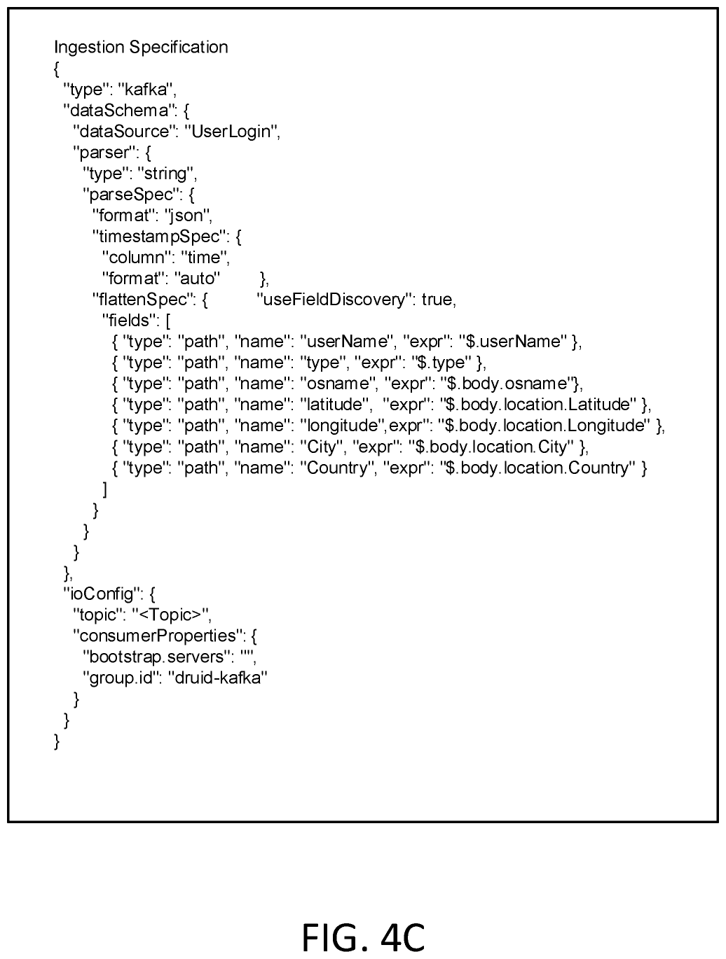

The configuration 114 is provided to the event manager 108. The configuration 114 specifies details about the database 106 (e.g., the type of database) and associated parameters for database schema generation (e.g., the database field attributes), such as shown in the examples of FIGS. 3A and 4A. Based on the configuration 114, the event manager 108 analyzes the messages 120 (e.g., events generated by the application environment 102) and transmits the analysis to the administrator console 112 for display to and review by the user. In some examples, the schema registry 110 provides a database schema 116 to the event manager 108. At the administrator console 112, administrators, engineers, analysts, and other users can view the messages 120. A user at the administrator console 112 can analyze the messages 120 and take actions for managing how the messages 120 are ingested into the database(s) 106, which is performed according to the database schema 116. The database schema 116 defines the structure of the database 106. Different databases can have different database schemas. For example, the user can modify the database schema 116 to define the structure of the database 106 to accommodate data in the messages 120. The database schema 116 is then registered with the schema registry 110. After the database schema 116 is registered with the schema registry 110 then the messages 120 received from the message broker 104 are processed using the database schema 116. The database schema 116 can be modified based on additions and modifications to the messages 120.

If the database 106 supports direct ingestion from the message broker 104, then a database ingestion specification 118 is generated that can be used for ingesting the messages 120 into the database 106. For example, the ingestion specification 118 can include a database schema, which configures the database name and other parameters; an input configuration, which instructs the database about how to connect to the message broker 104 and how to parse the messages 120; and any other parameters needed to support the ingestion method used to ingest or otherwise load data from the messages 120 into the database 106. The ingestion specification 118 can be validated and/or updated by the user as needed.

The event manager 108 is configured to produce an analysis 122 to the administrator console. As discussed in further detail with respect to FIG. 2, the event manager 108 processes the incoming messages 120 from the message broker 104 to identify the attributes that are present (or absent) in the messages 120, and to define or modify the database schema 116 and/or the database ingestion specification 118 that is used to store data encoded in the messages 120 in the database 106 according to those attributes.

In some examples, the system 100 can include a workstation, a laptop computer, a tablet, a mobile device, or any suitable computing or communication device. One or more components of the system 100, including the event manager 108, can include or otherwise be executed using one or more processors, volatile memory (e.g., random access memory (RAM)), non-volatile machine-readable mediums (e.g., memory), one or more network or communication interfaces, a user interface (UI), a display screen, and a communications bus. The non-volatile (non-transitory) machine-readable mediums can include: one or more hard disk drives (HDDs) or other magnetic or optical machine-readable storage media; one or more machine-readable solid state drives (SSDs), such as a flash drive or other solid-state storage media; one or more hybrid machine-readable magnetic and solid-state drives; and/or one or more virtual machine-readable storage volumes, such as a cloud storage, or a combination of such physical storage volumes and virtual storage volumes or arrays thereof. The user interface can include one or more input/output (I/O) devices (e.g., a mouse, a keyboard, a microphone, one or more speakers, one or more biometric scanners, one or more environmental sensors, and one or more accelerometers, etc.). The display screen can provide a graphical user interface (GUI) and in some cases, may be a touchscreen or any other suitable display device. The non-volatile memory stores an operating system (OS), one or more applications, and data such that, for example, computer instructions of the operating system and the applications, are executed by processor(s) out of the volatile memory. In some examples, the volatile memory can include one or more types of RAM and/or a cache memory that can offer a faster response time than a main memory. Data can be entered through the user interface. Various elements of the system 100 (e.g., the application environment 102, the message broker 104, the event manager 108, the database 106, the administrator console 112, and/or the schema registry 110) can communicate via the communications bus or another data communication network.

The system 100 described herein is an example computing device and can be implemented by any computing or processing environment with any type of machine or set of machines that can have suitable hardware and/or software capable of operating as described herein. For example, the processor(s) of the system 100 can be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations can be hard coded into the circuitry or soft coded by way of instructions held in a memory device and executed by the circuitry. A processor can perform the function, operation, or sequence of operations using digital values and/or using analog signals. In some examples, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multicore processors, or general-purpose computers with associated memory. The processor can be analog, digital, or mixed. In some examples, the processor can be one or more physical processors, which may be remotely located or local. A processor including multiple processor cores and/or multiple processors can provide functionality for parallel, simultaneous execution of instructions or for parallel, simultaneous execution of one instruction on more than one piece of data.

The network interfaces can include one or more interfaces to enable the system 100 access a computer network such as a Local Area Network (LAN), a Wide Area Network (WAN), a Personal Area Network (PAN), or the Internet through a variety of wired and/or wireless connections, including cellular connections. In some examples, the network may allow for communication with other computing platforms, to enable distributed computing. In some examples, the network may allow for communication with the application environment 102, the message broker 104, the event manager 108, the database 106, the administrator console 112, the schema registry 110, and/or other parts of the system 100 of FIG. 1.

Example Process

FIGS. 2A-B show a flow diagram of an example system event analysis and database management process 200, in accordance with an example of the present disclosure. The process 200 can be implemented, for example, by the event manager 108 of the system 100 of FIG. 1. The process 200 includes receiving 202 the configuration 114 of FIG. 1, which includes details such as defining the message broker 104 that transmits the messages 120 to the event manager 108, a name and source of the database 106, a database topic and subscription details, a primary identifier or other key attribute associated with the database 106, a time window or time frame to be used for analysis (e.g., a definition of the start and end times for messages, events, or other records to be analyzed), and/or other information associated with the data in the messages 120 of FIG. 1. Topics are logical entities in the message broker 104, where messages, events, and other records are published by a producer. These messages, events, or other records are then stored in or otherwise processed by the message broker 104 according to the configuration 114. A subscription in the message broker 104 identifies the messages, events, or other records associated with the topic specified by the configuration 114. A topic in the message broker 108 can have multiple subscribers. Subscriptions indicate where the messages are to be read (also referred to as check pointing) by the event manager 108 or another consumer of the data. The messages, events, or other records are then transmitted to the event manager 108 for analysis and other processing. On every iteration by the event manager 108 or other consumer of the messages 120, the check pointing defined by the subscription indicates where the new messages are to be received from.

The process 200 further includes determining 204 the message broker 104 from which the event manager 108 receives the messages 120. Note that there can be more than one message broker 104, depending on how the messages 120 are to be received from the application environment 102. Each message broker 104 is specified by the configuration 114. For example, the message broker 104 can be Apache Kafka, Azure Service Bus, or any other message broker that is configured to process messages from the application environment 102. The message broker 104 is the source of all incoming messages to be processed by the event manager 108. In some examples, if the database 106 supports an ingestion specification 118, the database 106 can be configured to ingest messages directly from the message broker 104 according to the ingestion specification 118.

The process 200 further includes receiving 206, by the event manager 108, the messages 120 transmitted from the application environment 102 via the message broker 104. For example, as noted above, the configuration 114 can specify a time window or time frame to be used for filtering the messages 120 that are to be analyzed (e.g., between 1 Jan. 2020 at 12:01 am and 7 Jan. 2020 at 11:59 pm), and/or the configuration 114 can specify other attributes for filtering the messages 120 (e.g., by user, by source, by topic, by subscription, by database type, etc.). In this manner, the event manager 108 will receive and process any messages 120 that include events occurring within the time window specified by the configuration 114, or any messages 120 that otherwise satisfy any other criteria specified by the configuration 114.

The process 200 further includes analyzing 208, by the event manager 108, the incoming messages 120 received from the message broker 104 to produce the analysis 122 of FIG. 1 according to the attributes specified in the configuration 114. The analysis performed is based on the data type of the value of each attribute in the incoming message 120, event, or record. For example, if the type of the attribute is an integer, then the analysis 122 can include providing a minimum, maximum, average, mean, or other statistical value of the attribute among all of the messages 120. In another example, if the type of the attribute is a string, then the analysis 122 can include providing a number of empty, null, duplicate, or missing values among all of the messages 120. The attributes of each message 120 can be analyzed alone or in different combinations, such as by event type, event path, availability, uniqueness, or presence (or absence) of each field in the message for each event type provided as the primary identifier. This enables selection, from the analysis 122, of the attributes of interest based on the needs and use cases for a given system. By default, all attributes can be selected for inclusion in the database schema 116, or certain attributes can be selected for inclusion in the database schema 116. In one such example, referring to FIGS. 3B and 4B, if the messages 120 include the attribute “user.Login”, then the analysis 122 will determine how frequently the attribute “user.Login” is present (or, conversely, how often the field is empty) across all messages 102 being analyzed. If, for instance, the attribute “user.Login” is empty more than 20% of the time among all messages 102 being analyzed, then the analysis 122 indicates that the attribute “user.Login” has an “EmptyPercent: 20.” In another example, the analysis 122 can include determining the maximum, minimum, mean, and/or other statistical information of any numeric attributes of the messages 102 being analyzed. For instance, if the messages 120 include the attribute “user.Login” with a unique value of “city=Bengaluru”, then the analysis 122 indicates that the attribute “city” includes the unique value “city=Bengaluru” 75% of the time among all messages 102 being analyzed. Other examples will be apparent in view of this disclosure. For instance, the analysis 122 can indicate: duplicated data: number or percentage of duplicated attribute values in the messages 120; missing data: number or percentage of null/empty attribute values in the messages 120; maximum, minimum, mean, standard deviation, etc. for attribute values that are integers; unique values for all attributes; and language of the attribute value (e.g., English, etc.).

The analysis 122 performed on the messages 120 is collated and transmitted as an output 210 to the administrator console 112, such as shown in FIGS. 3B and 4B (data/attributes analysis). An administrator or other user can review and modify the analysis 122. For example, if the analysis 122 includes attributes that the administrator wishes to remove or modify, the administrator can edit the analysis 122 accordingly via the administrator console 112. Similarly, if the analysis 122 does not include attributes that the administrator wishes to include, the administrator can edit the analysis 122 accordingly. In some examples, the administrator can take no action to modify or otherwise edit the analysis 122.

The analysis 122, as transmitted by the event manager 108 and/or the administrator via the administrator console 112, is then registered 212 with the schema registry 110 as the schema 116. If there are multiple databases 106, then separate schemas 116 can be registered for each database. An example schema 116 is shown in FIGS. 3B and 4B. The schema 116 includes, for example, the name of each field and corresponding data type for the database 106. The schema 116 defines the relationship between the data in the messages 120 and the fields of the database 106 into which the messages are to be stored. For example, as shown in FIGS. 3B and 4B, the schema includes the attributes “osName” and “mfaAuthType” as in the analysis 122 transmitted by the event manager 108. In some examples, the administrator can specify whether to apply the database schema 116 to the database 106, and whether to generate the ingestion specification 118 if the database 106 supports it. For instance, each of the attributes present in the messages 120, the type of each attribute (e.g., string, integer, etc.), the presence of any null values, duplicates, and so forth, as provided by the analysis 122, is registered with the database schema 116, such as shown in FIGS. 3B and 4B.

The process 200 further includes determining 214, by the event manager 108, the type of the database 106 from the configuration 114. For example, the database type can be a relational database, a time series or analytical database, a graph database, or any other type of database or datastore. After the database is determined from the configuration 114, the existing (current) schema 116 is fetched 216 from the database 106 by the event manager 108. Next, the event manager 108 updates 218 the schema 116 according to the attributes specified in the analysis 122, as described above. For example, if the analysis 122 specifies one or more attributes that are not in the existing schema 116, then the schema 116 is updated to include those attributes specified in the analysis 122. If the configuration 114 provides that the updated schema 116 is to be applied to the database 106, then the event manager 108 applies 220 the updated schema 116 to the database 106. If the event manager 106 determines 214 that there are multiple databases, then the event manager 106 fetches 216, updates 218, and applies 220 the updated schema 116 to each of the databases 106, accordingly. If the configuration 114 does not provide that the updated schema 116 is to be applied to the database 106, then the event manager 104 transmits 222 the updated schema 116 as an output via the administrator console 112 for further processing by the administrator.

If the database 106 supports direct ingestion of the messages 120 from the message broker 104, and the configuration 114 provides that the ingestion specification 118 is to be generated, then the event manager 108 generates 224 the ingestion specification 118, such as shown in FIGS. 3C and 4C. The ingestion specification 118 is specific to the database 106, and includes the attributes provided by the analysis 122. If the configuration 114 provides that the ingestion specification 118 is to be registered with the database 106, then the event manager 108 registers 226 the ingestion specification 118 with the database 106. If the configuration 114 does not provide that the ingestion specification 118 is to be registered with the database 106, then the event manager 104 transmits 228 the ingestion specification 118 as an output via the administrator console 112 for further processing by the administrator.

It will be appreciated that the process 200 is extensible for use with any message broker and database that is specified in the configuration 114. For example, analysis of events can be performed on any messages 120 that are received by the event manager 108, and the schema 116 for ingestion specification 118 can be accordingly created or otherwise modified based on the resulting analysis 122.

The foregoing description and drawings of various embodiments are presented by way of example only. These examples are not intended to be exhaustive or to limit the present disclosure to the precise forms disclosed. Alterations, modifications, and variations will be apparent in light of this disclosure and are intended to be within the scope of the present disclosure as set forth in the claims.

Also, the phraseology and terminology used herein is for the purpose of description and should not be regarded as limiting. Any references to examples, components, elements or acts of the systems and methods herein referred to in the singular can also embrace examples including a plurality, and any references in plural to any example, component, element or act herein can also embrace examples including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” can be construed as inclusive so that any terms described using “or” can indicate any of a single, more than one, and all of the described terms. In addition, in the event of inconsistent usages of terms between this document and documents incorporated herein by reference, the term usage in the incorporated references is supplementary to that of this document; for irreconcilable inconsistencies, the term usage in this document controls.

What is claimed is:

1. A method of updating a database schema, the method comprising:
receiving a plurality of messages from an application environment;
analyzing, as specified by a configuration, each of the messages to produce an analysis including a list of attributes and corresponding attribute values;
fetching a schema from either a database or a schema registry associated with the database;
updating the schema to produce an updated schema based on one or more of the attributes in the list of attributes; and
applying the updated schema to the database.

2. The method of claim 1, wherein the configuration specifies a start time and an end time for messages to be analyzed.

3. The method of claim 1, further comprising generating an ingestion specification based on the database and the one or more of the attributes in the list of attributes, and registering the ingestion specification with the database.

4. The method of claim 1, further comprising transmitting the analysis and/or the updated schema to an operator console, and receiving a modified analysis from the operator console, the modified analysis including at least one modification to the one or more of the attributes in the list of attributes, wherein updating the schema is further based on the modified analysis.

5. The method of claim 1, wherein the plurality of messages includes a user login event, a security event, a processing event, and/or data representing activity occurring within the application environment.

6. The method of claim 5, wherein at least one attribute of the plurality of messages includes a numerical value, and wherein the analysis includes a minimum, maximum, average, mean, or a statistical value of the at least one attribute of the plurality of messages.

7. The method of claim 5, wherein at least one attribute of the plurality of messages includes a text value, and wherein the analysis includes a number of empty, null, duplicate, or missing values of at least one attribute of the plurality of messages.

8. A computer program product including one or more non-transitory machine-readable mediums having instructions encoded thereon that when executed by at least one processor cause a process to be carried out, the process comprising:
receiving a plurality of messages from an application environment;
analyzing, as specified by a configuration, each of the messages to produce an analysis including a list of attributes and corresponding attribute values;
fetching a schema from either a database or a schema registry associated with the database;
updating the schema to produce an updated schema based on one or more of the attributes in the list of attributes; and
applying the updated schema to the database.

9. The computer program product of claim 8, wherein the configuration specifies a start time and an end time for messages to be analyzed.

10. The computer program product of claim 8, wherein the process further comprises generating an ingestion specification based on the database and the one or more of the attributes in the list of attributes, and registering the ingestion specification with the database.

11. The computer program product of claim 8, wherein the process further comprises transmitting the analysis and/or the updated schema to an operator console.

12. The computer program product of claim 11, wherein the process further comprises receiving a modified analysis from the operator console, the modified analysis including at least one modification to the one or more of the attributes in the list of attributes, wherein updating the schema is further based on the modified analysis.

13. The computer program product of claim 1, wherein the process further comprises registering the updated schema with the schema registry associated with the database.

14. The computer program product of claim 1, wherein the plurality of messages includes a user login event, a security event, a processing event, and/or data representing activity occurring within the application environment.

15. A system comprising:
a storage; and
at least one processor operatively coupled to the storage, the at least one processor configured to execute instructions stored in the storage that when executed cause the at least one processor to carry out a process including
receiving, by an event manager, a plurality of messages from an application environment;
analyzing, by the event manager and as specified by a configuration, each of the messages to produce an analysis including a list of attributes and corresponding attribute values;
fetching, by the event manager, a schema from either a database or a schema registry associated with the database;
updating, by the event manager, the schema to produce an updated schema based on one or more of the attributes in the list of attributes; and
applying, by the event manager, the updated schema to the database.

16. The system of claim 15, wherein the configuration specifies a start time and an end time for messages to be analyzed.

17. The system of claim 15, wherein the process further comprises generating, by the event manager, an ingestion specification based on the database and the one or more of the attributes in the list of attributes, and registering the ingestion specification with the database.

18. The system of claim 15, wherein the process further comprises transmitting, by the event manager, the analysis and/or the updated schema to an operator console.

19. The system of claim 18, wherein the process further comprises receiving, by the event manager, a modified analysis from the operator console, the modified analysis including at least one modification to the one or more of the attributes in the list of attributes, wherein updating the schema is further based on the modified analysis.

20. The system of claim 15, wherein the process further comprises registering, by the event manager, the updated schema with the schema registry associated with the database.
